(19) United States
(12) Patent Application Publication
(10) Pub. No.: US 2023/0406079 A1
(43) Pub. Date: Dec. 21, 2023

(54) COVER ASSEMBLY FOR CARGO BED OF PICKUP TRUCK

(71) Applicant: David Ickowicz, East Brunswick, NJ (US)

(72) Inventor: David Ickowicz, East Brunswick, NJ (US)

(21) Appl. No.: 18/228,002

(22) Filed: Jul. 31, 2023

(51) Int. Cl. B60J 7/16; B60J 7/10

(52) U.S. Cl. CPC B60J 7/1621; B60J 7/102

(57) ABSTRACT

The present invention provides a cover assembly for a cargo bed of a pickup truck, utility truck, or other vehicle. The cover assembly is fixed onto the sidewalls of the cargo bed to provide cover or shelter thereon to protect the load from weather, vandalism, etc. The cover assembly is expandable in all three axes or in any two axes or in any axis and thus can be used for different size cargo beds. The cover assembly includes rails mounted on the sidewalls of the cargo bed, panels, edge frames mounted to the rails, and corner frames. The assembly includes a door assembly that includes one or more door flaps movably hinged to one of the panels. The cover assembly includes support assembly mounted to the rails that includes beams and columns connected together by means of connectors.

### TECHNICAL FIELD

The present invention relates to automobile engineering. More particularly, the present invention relates to a cover assembly for a cargo bed of a pickup truck, utility truck, or another vehicle and that can be fixed to the sidewalls of the cargo bed to provide cover or shelter thereon to protect the load from weather, vandalism, etc. Further, the presented cover assembly is capable of extending in size along all three axes which makes it suitable for use with different sizes of the cargo bed of different types of pickup trucks.

### BACKGROUND

Cargo beds are usually constructed as open beds for carrying a variety of loads therein. However, it is often desirable to cover the load to protect it from weather, vandalism, etc. Also, sometimes, it is noted that the beds of the pickup truck, utility truck, truck, or another vehicle need to be used without cover assembly. The permanent bed covers restrict vehicle use. Therefore, numerous bed cover assemblies have been attempted which may be removable or which may be deployed only when desirable. However, it is difficult to use such conventional cover assemblies for cargo beds of different sizes. Some of the existing prior art that discloses different types of cover assemblies for the truck bed are as under:

US patent publication 2020331329 to AGRI COVER INC. discloses a folding tonneau cover having a secured flexible hinge that includes an elongated support member secured to an underside of one of the rigid panels; wherein the elongated support member has a main portion and a flange; wherein the main portion has an upper portion that is secured to an underside of the respective rigid panel and the flange extends away from the upper portion such that the flange resides at least partially below the respective underside and at least a portion of one of the two side portions.

Another prior art U.S. Pat. No. 8,087,716 to Kramer Jerry discloses a cap for a pickup truck bed that comprises a base support frame assembly including a pair of side guide rails; a hoop support frame attached each at the opposite end of said side guide rails; and a pair of flexible side panels.

Another, U.S. Pat. No. 9,227,491 to Story Jr James K; Caudill Deborah J discloses a slidable cover for a truck rack that comprises a base support frame assembly that comprises a cover plate and a slidable attachment means, wherein said cover plate is a rigid horizontal impermeable rectangular-shaped planar member and said slidable attachment means comprises a set of two T-rails, a set of two C-channels, and a set of two offset brackets.

The applicant has noted that prior art documents disclose T, L, C, U, V, F, and E-shaped brackets/channels for holding panels to form the cover assemblies. Such brackets have less life due to unequal stress distribution therein and are costly to manufacture and may require more space. Cited references use symmetric nuts for tightening said brackets/panels in the brackets which is not desirable in some cases. Importantly, the prior art cover assemblies are fixed in terms of their sizes and are thus not suitable for use with cargo beds of different sizes. One needs to have different custom-made cover assemblies for use with the differently sized cargo bed.

In view of the above prior art, it can be understood that many cover assemblies have been designed in an attempt to provide a similar solution, however, they are complex, expensive, and cumbersome. Although a number of solutions in the form of cargo bed cover assemblies have been proposed in the past, none of them proposes a simplified cargo bed cover assembly design that may be adjustable in size in three axes, have support assembly to rigidly hold the cover assembly in an upright position, and that may be optionally provided with one or more hinged doors made out of panels.

### SUMMARY

It is an object of the present invention to provide a cover assembly for a cargo bed of a pickup truck, utility truck, or other similar vehicle and that can be fixed to the sidewalls of the cargo bed to provide cover or shelter thereon to protect the load from weather, vandalism, etc.

It is another object of the present invention to provide a cover assembly for a cargo bed of a pickup truck that is expandable in all three axes or along two axes or along any one axis and thus can be used for different size cargo beds. In other words, a single cover assembly can be fixed on different size cargo beds thereby not requiring a user to have multiple cover assemblies depending upon the sizes of the cargo beds.

It is another object of the present invention to provide a cover assembly for the cargo bed of a pickup truck that can be installed D.I.Y. style by a non-professional with no special tools.

It is another object of the present invention is to provide a cover assembly for a cargo bed of a pickup truck that is user-friendly as it is easy to assemble and disassemble if needed.

It is another object of the present invention is to provide a cover assembly for a cargo bed of a pickup truck that uses a number of edge frames assembled together in pairs by means of fasteners and configured to hold panels, and corner frames are assembled together in pairs and connected together by means of nuts to hold edge frames.

According to an embodiment, a cover assembly for a cargo bed of a pickup truck includes a plurality of rails mounted on sidewalls of the cargo bed of the pickup truck, a plurality of panels, a plurality of edge frames configured and supported on the plurality of rails. Each edge frame of the plurality of edge frames comprises a pair of edge brackets fixed together to form a first-panel gap, and a second-panel gap therebetween for receiving an edge portion of a first panel and a second panel of the plurality of panels there inside.

According to the same embodiment, the cover assembly further comprises plurality of corner frames, wherein each corner frame of the plurality of corner frames comprises a pair of corner brackets fixed together to form a first edge frame gap, a second edge frame gap, and a third edge frame gap therebetween for receiving a side portion of a first edge frame, a second edge frame and a third edge frame of the plurality of edge frames respectively.

According to the same embodiment, the plurality of panels, the plurality of edge frames, and the plurality of corner frames when assembled together form a canopy with a loading space there inside.

Various objects, features, aspects, and advantages of the present invention will become more apparent from the following detailed description of the embodiments of the invention, along with the accompanying drawings in which numerals represent like components.

### BRIEF DESCRIPTION OF DRAWINGS

So that the manner in which the above-recited features of the present invention can be understood in detail, a more particular description of the invention, briefly summarized above, may have been referred to by embodiments, some of which are illustrated in the appended drawings. It is to be noted, however, that the appended drawings illustrate only typical embodiments of this invention and are therefore not to be considered limiting of its scope, for the invention may admit to other equally effective embodiments. These and other features, benefits, and advantages of the present invention will become apparent by reference to the following text figure, with like reference numbers referring to like structures across the views, wherein:

FIGS. 1A-1B. shows views of a cover assembly installed on a cargo bed of a pickup truck in accordance with various embodiments of the present invention;

FIGS. 2 and 3. show the cover assembly of FIG. 1A-1B unmounted from the truck bed;

FIG. 4A-4B. shows sectional views of FIG. 3 along A-A and B-B respectively;

FIG. 5A-5B shows an edge frame with panels and supporting door and door panels;

FIG. 6 shows an exploded view of the edge frame of FIG. 5A or 5B;

FIG. 7. shows a view of an edge bracket of the edge frame FIG. 5A or 5B;

FIG. 8. shows a sectional and partially exploded view of the cover assembly with a corner frame disengaged from the assembly of FIG. 2 or 3;

FIG. 9. shows an underside sectional view of the cover assembly (section ‘C’ of FIG. 3) specifically showing the corner frame and connectivity of the plurality of edge frames with the corner frame;

FIG. 10. shows a 3D view of an asymmetric nut in FIG. 9;

FIG. 11A shows the cover assembly of FIG. 3 with a door assembly having a single flap in an opened state;

FIG. 11B shows the cover assembly of FIG. 3 with a door assembly having multiple flaps in an opened state;

FIG. 12 shows the cover assembly of FIG. 3 with multiple flaps in a closed state;

FIG. 13 shows a support assembly installed on the truck bed prior to installing the complete cover assembly; and

FIGS. 14A-14B shows underside views of the cover assembly of FIG. 3 in use and upholding the edge frames, corner frames, and panels.

### DETAILED DESCRIPTION

Some embodiments, illustrating its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, several materials are identified as suitable for various facets of the implementations. These materials are to be treated as exemplary and are not intended to limit the scope of the invention.

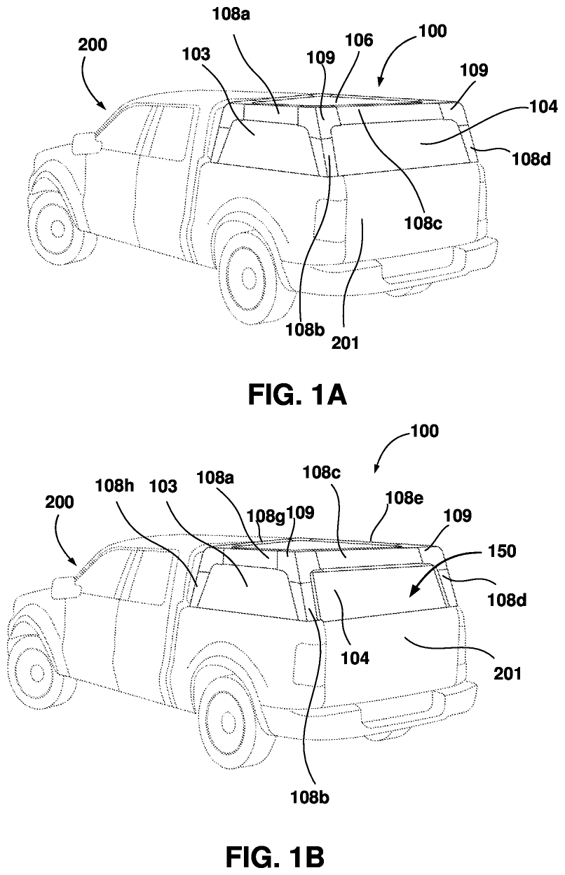

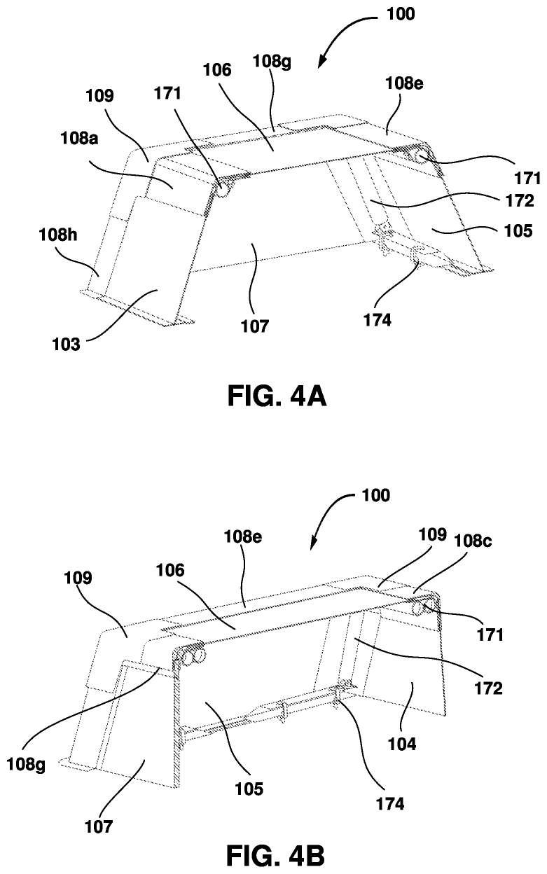

The various features and embodiments of the present invention will now be described in conjunction with the accompanying figures, namely FIGS. 1-13, and 14A-14B, which should be regarded as merely illustrative without restricting the scope and ambit of the present invention.

The present invention provides a cover assembly for a cargo bed of a pickup truck, utility truck, or similar vehicle. The cover assembly is mounted to the top sill of the sidewalls of the cargo bed to provide cover or shelter thereon to protect the load from weather, theft, vandalism, etc. FIGS. 1A-1B shows views of the cover assembly 100 installed on a cargo bed 201 of a pickup truck 200. The assembly 100 is expandable in all three axes (X, Y, and Z axis), or in any two axes (XY, XZ, or YZ), or along any one axis (X, Y, or Z) and thus can be reused for different size cargo beds. The assembly is simple in construction, and easy to install. The assembly is user-friendly as it is easy to assemble and disassemble if needed.

From herein afterward, the cover assembly is referred to as an assembly 100.

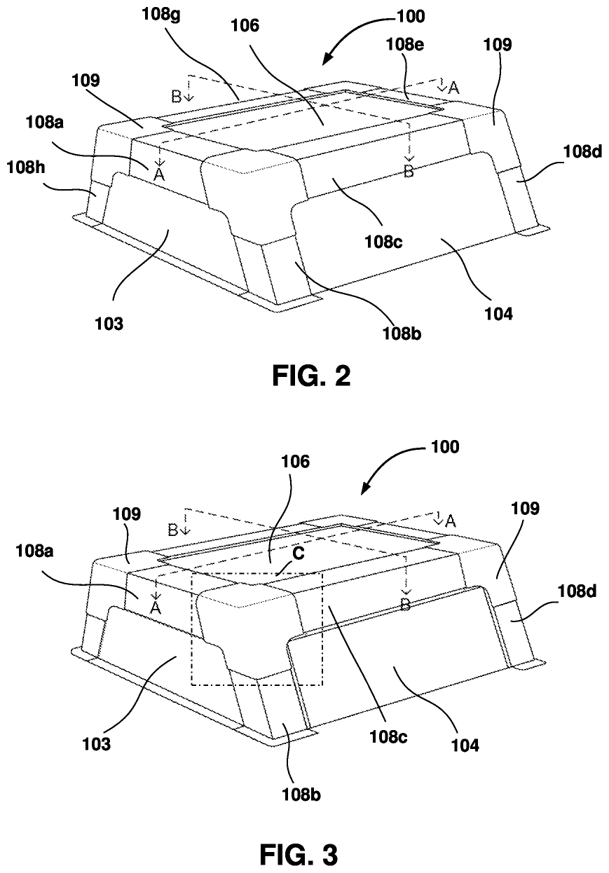

Referring now to FIGS. 2, 3, 4A, and 4B, the assembly 100 includes a plurality of rails 101, 102, a plurality of panels 103-107, a plurality of edge frames 108a-108h, and a plurality of corner frames 109.

The panels 103, 104, 105, 106, 107 are made from metal sheets, plastic, fiber or any other material. In one embodiment, the panels 103-107 may be made from heat-insulating material that reduces the effect of weather, and temperature on the load. In another embodiment, the panels 103-107 may be made from a transparent material. In a further embodiment, the panels 103-107 may include a mesh for better ventilation. In furthermore embodiment, one or more panels may include a window made up of transparent material configured for easy inspection of the goods loaded on the cargo bed 201. In some embodiment, the one or more panels 103-107 may be configured in an aerodynamic shape.

The rails 101, 102 are mounted on the sidewalls 201a of the cargo bed 201. The rails 101, 102 may include tabular frames, in some embodiments. In another example, the panels 103-107 may include lip allowing them to be clamped to rails 101, 102 or on the top sill of sidewalls. The mounting means used for rails 101, 102 may include welded joint, bolted joint, or a like joint. In another alternative embodiment of the present invention, the edge frames 108a-108h are configured on the rails 101, 102.

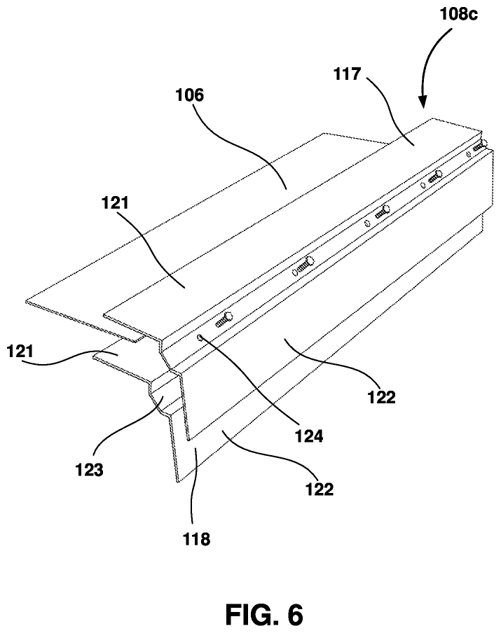

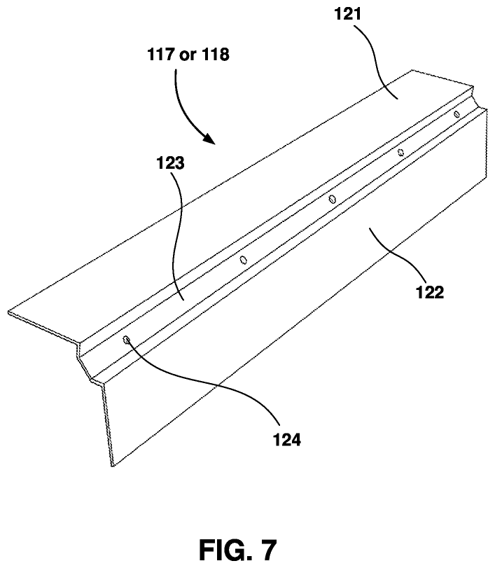

Referring specifically to FIG. 6, a single edge frame 108c is shown in an exploded configuration. The edge frame 108c includes a pair of edge brackets 117, 118. The edge frames 108a-108h may be curved out at the bottom. The edge brackets 117, 118 include a first edge bracket 117 and a second edge bracket 118. The edge brackets 117, 118 are made from metal, metal alloys, hard polymers, fiber, or using any combination thereof. The first edge bracket 117 and the second edge bracket 118 are fixed together by means of a bolted joint without or with panel 103, or 104, or 105, or 106, or 107. The first edge bracket 117 and the second edge bracket 118 are structurally identical. In another embodiment of the present invention, the first edge bracket 117 and the second edge brackets 117, 118 may be structurally different. The edge brackets 117, 118 include a first segment 121, a second segment 122, and maybe a curved portion 123. The curved portion 123 is configured between the first segment 121 and the second segment 122. The curved portion 123 is provided with holes 124. The curved portion 123 is integral to the first segment 121 and the second segment 122 as seen in FIG. 7. In another embodiment, an angled notch is configured between the first segment 121 and the second segment 122 instead of the curved portion 123.

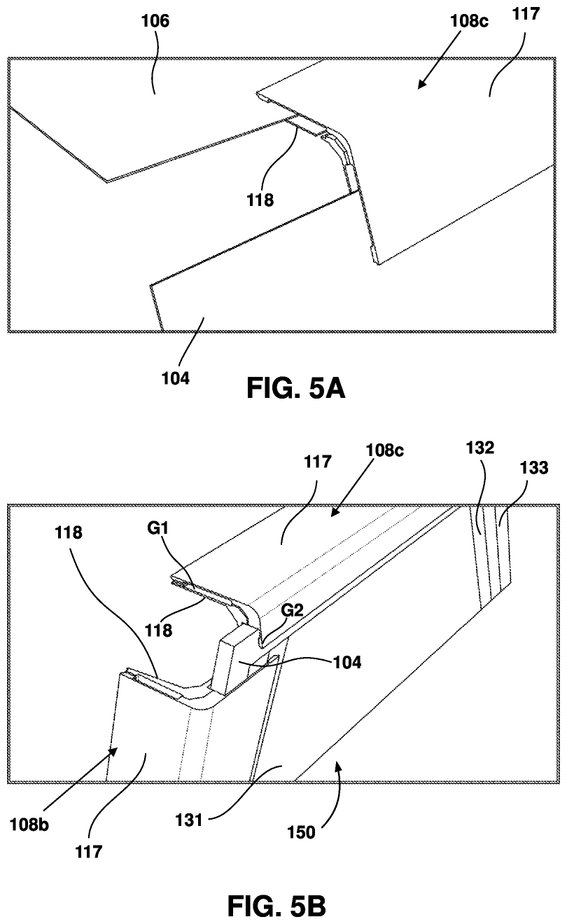

The edge brackets 117, 118 are fixed together to form a first-panel gap G1 and a second-panel gap G2 therebetween (FIG. 5B). The depth of internal space of the gaps G1, G2 allows for the panels 103-107 to be held in place at various positions along edge thereof. Thus, the externally exposed area of panels 103-107 is able to alter depending on the depth panels 103-107 inserted into the gaps G1, G2, thus allowing for the entirety of the size of the assembly 100 to change in size. In the present embodiment of the invention, the internal space of the first and the second-panel gap G1 and G2 may form a rectangular cross-section. In an illustrated example as seen in FIG. 5A and FIG. 5B, the first-panel gap G1 and the second-panel gap G2 receive an edge portion of the first-panel 106 and the second-panel 104 thereinside respectively. The panels 103-107 are slidably adjustable within the panel gaps G1 and G2 of each of the edge frames 108a-108h during assembly. The first-panel gap G1 and the second-panel gap G2 represent the housing of the different sides of panels 103-107, G1 the roof and G2 the side panel or rear panel or front panel. The first-panel gap G1 and second-panel gap G2 may be identical in terms of thickness or may be different based on the thicknesses of the adjacent panels. In another embodiment, each of the edge frames is designed to hold two panels (of different thicknesses, or the same thickness), namely 104 and 106 may have different thicknesses and 103 and 106 may have the same thickness.

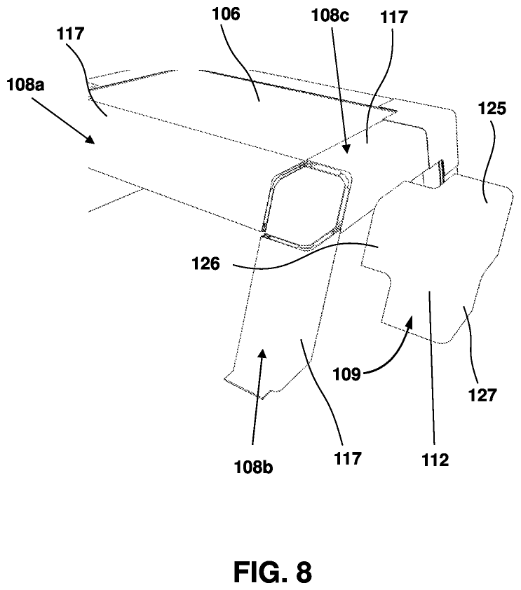

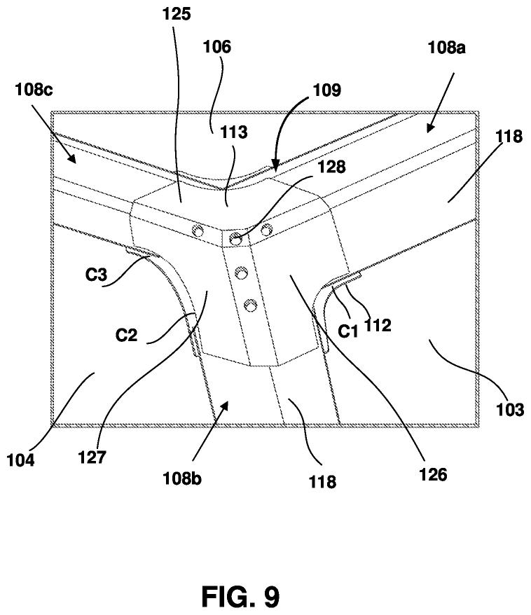

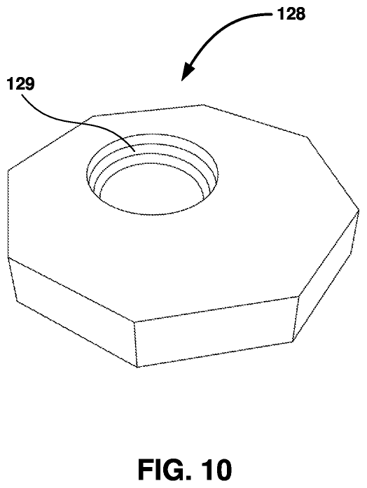

The corner frame 109 includes a pair of corner brackets 112, 113. Each of the pair of corner brackets 112, 113 includes a first-corner bracket 112 and a second-corner bracket 113. Referring now to FIGS. 8 and 9, the corner brackets 112, 113 comprise a first arm 125, a second arm 126, and a third arm 127. The first arm 125, the second arm 126, and the third arm 127 may be perpendicular to each other. In one more embodiment, the angle between each of the two arms is predefined by the manufacturer based on design requirements. Each arm is configured with a plurality of holes. A bolted joint is used for fixing the corner brackets 112, 113 to ends of the length of the edge brackets 117, 118 at a precise point along the length to stop the movement and loosening of the structure. The bolted joint uses an asymmetrical nut 128. The asymmetrical nut 128 includes a plurality of sides. Each side is adapted to have a different thickness. The multitude of thickness in the bolt 128 together with a multitude of holes to screw it allows for a very large potential number of positions to lock a position thereof. This ensures variability in the total volume of the assembly 100.

Referring now to FIG. 10, the asymmetrical nut 128 includes a threaded hole 129 for bolt engagement. The asymmetrical nut 128 is adjustable as the space required by each side is different. The axis of the threaded hole 129 may or may not be the same as that of the asymmetrical nut 128. The corner brackets 112, 113 are fixed together to form a first-edge frame gap C1, a second-edge frame gap C2, and a third-edge frame gap C3 therebetween. The edge frame gaps C1-C3 receive side portions of the edge frames 108a, 108b, 108c respectively. The edge frames 108a, 108b, 108c are slidably adjustable within the edge frame gaps C1-C3 of the corner frames 109 to facilitate adjustability of the cover assembly 100 in all three directions X, Y, Z during assembly, thereby allowing for a variability in the total volume of the assembly 100. In one more embodiment of the present invention, the assembly 100 is expandable along any single axis i.e., along X, or Y, or Z axis. This is achieved by restricting the freedom of motion of edge frames 108a, or 108b or 108c along remaining axes, i.e., YZ, XZ or XY respectively. In one more embodiment of the present invention, the assembly 100 is expandable along any two axes i.e., along XY, or YZ or XZ axes. This is achieved by restricting the freedom of motion of edge frames 108a, or 108b or 108c along remaining axis. In an example, a vertical extensibility of the assembly 100 along Y axis is restricted by fixing the edge frames 108b, 108d, 108h. Therefore, the edge frames 108b, 108d, 108h have less overhang allowing less movement of the panel 103, 104, 105, 107 thereinside. This arrangement maximizes the size of the opening at the deck.

The plurality of panels 103-107, the plurality of edge frames 108a-108h, and the plurality of corner frames 109, when assembled together, form a canopy-like structure with a loading space there inside. The canopy so formed provides roof-like cover or shelter on the cargo bed 201 to protect the load from weather, vandalism, etc.

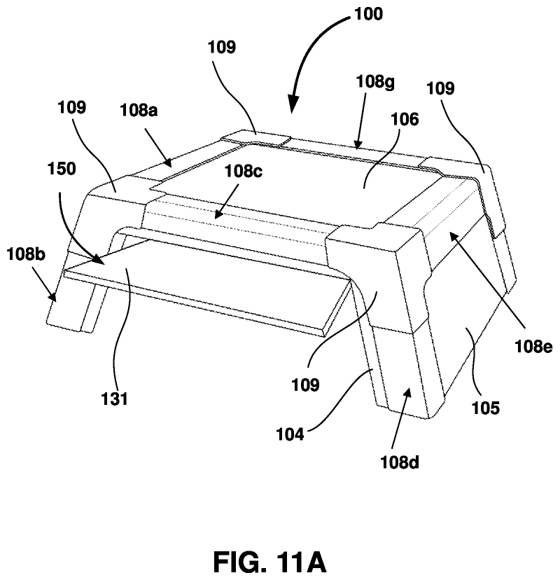

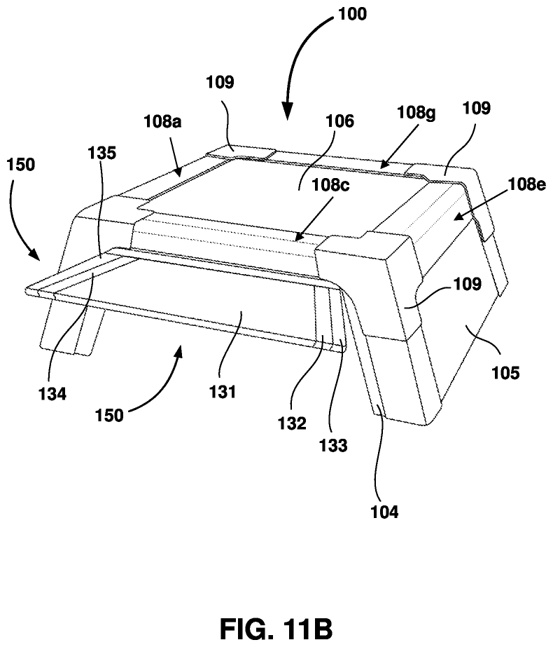

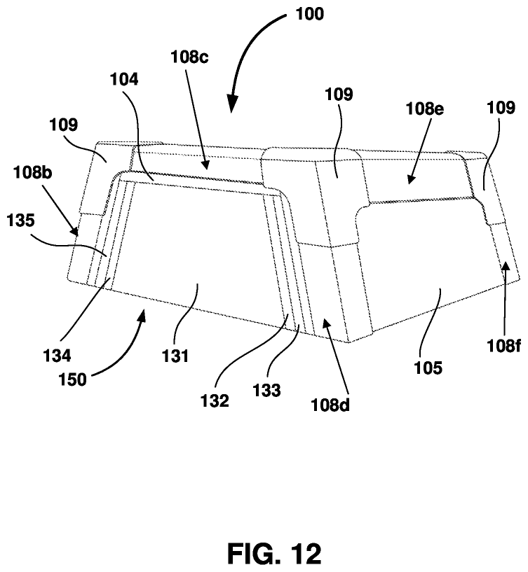

In another embodiment of the present invention, as seen in FIGS. 11A, the assembly 100 is provided with at least one door assembly 150. The door assembly 150 includes a first door flap 131. The first door flap 131 is movably hinged to a supporting panel 103 or 104 or 105 or 106 or 107. In the shown example, the door flap 131 is movably hinged to panel 104. The supporting panel 104 may be thicker than other panels 103, 105-107 of the cover assembly 100 in an embodiment. In another embodiment, the thicker of the panel 104 may be similar to other panels 103, 105-107. An edge portion of the first door panel 131 is hinged to the supporting panel 104 using a door hinge (not seen). In another embodiment of the present invention, as seen in FIGS. 11B and 12, the door assembly 150 includes more than one door flaps 131-135. The door flaps 131-135 are selectively couplable by means of a door lock. The door flaps 131-135 are couplable from inside using the door lock. The door lock can be latched, or a flange, or a sliding bolt. The door assembly 150 allows the user to close or open the assembly 100 from one or more sides whenever the user requires access to the load that the cover assembly 100 covers. The door flaps 131-135 are rotatable between open and closed positions thereof. Each of the door flaps 131-135 is hinged to the supporting panel 104 using a corresponding door hinge.

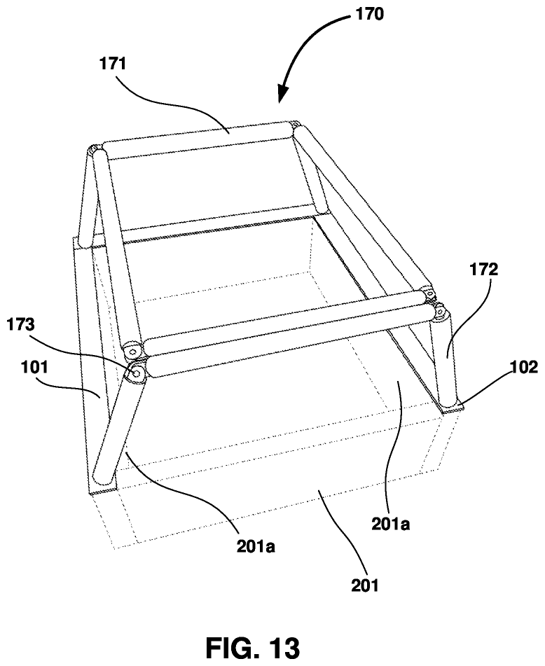

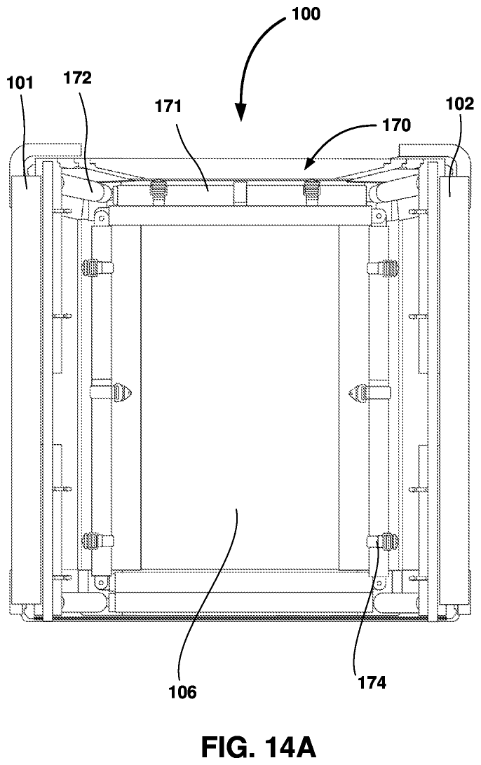

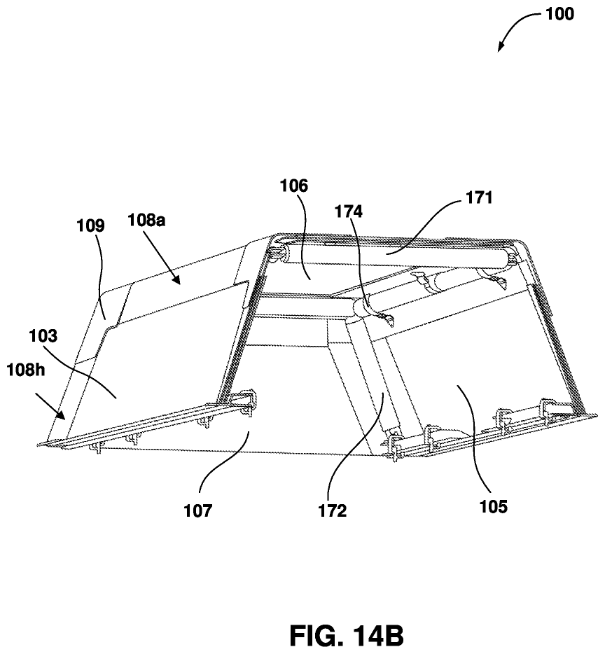

In another embodiment of the present invention, as seen in FIGS. 13, 14A, and 14B, the assembly 100 is provided with a support assembly 170. The support assembly 170 is mounted onto the plurality of rails 101, 102. The support assembly 170 includes a plurality of beams 171 and a plurality of columns 172. The beams 171 and columns 172 are connected together by means of connectors 173. In an exemplary non-limiting embodiment of the present invention, the beams 171 and the columns 172 have a circular cross-section. In another embodiment, the beams 171 and the columns 172 have a triangular, quadrilateral, or polygonal cross-sections. The support assembly 170 provides strength or rigid support to the cover assembly 100. The columns 172 and the beams 171 are telescopic. The columns 172 and the beams 171 are fastened to the cover assembly 100 by means of clips and straps 174, hooks, or nut bolts or using other means. The columns 172 and beams 171 are arranged inside the cover assembly 100. The support assembly 170 may not be visible from the outside when the cover assembly 100 is assembled on the sidewalls of the cargo bed 201. Although, FIGS. 13, 14A, and 14B show a specific arrangement for the support assembly 170. It should be understood that the support assembly 170 may be mounted or configured in many other arrangements.

The cover assembly 100 is removable from the cargo bed 201 of the pickup truck 200. In a given example, the assembly 100 is removed from the cargo bed 201 for installation on another cargo bed of another truck. The panels 103-107 are slidably adjusted inside the edge frames 108 as per the new dimensions of another cargo bed 201. The edge frames 108 are slidably adjustable within the edge frame gaps of the corner frames 109 in order to allow the cover assembly 100 to be used with a new size cargo bed 201 of the pickup truck 200.

The present invention has the advantage of providing the cover assembly 100 for the cargo bed 201 of the pickup truck 200 or similar vehicle that can be fixed to the sidewalls 201a of the cargo bed 201 to provide cover or shelter thereon to protect the load from weather, vandalism, etc. The assembly 100 is expandable in all three axes and thus can be used for different size cargo beds 201. The assembly 100 is simple in construction, and easy to install. The assembly 100 is user-friendly as it is easy to assemble and disassemble if needed. The assembly 100 uses the number of edge frames 108 assembled together in pairs by means of fasteners and configured to hold panels 103, 104, 105, 106, 107, and corner frames 109 are assembled together in pairs and connected together by means of nuts. Although, the embodiments described herein are directed toward the use of the cover assembly 100 with respect to the cargo bed 201. It should be understood that the cover assembly 100 of the present invention is capable of being used across many other applications, for example, the cover assembly as described above or with minor design changes and with or without some of the components described above can be used as outdoor shelters or tents, or for other applications.

It should be understood according to the preceding description of the present invention that the same is susceptible to changes, modifications and adaptations, and that the said changes, modifications and adaptations fall within scope of the appended claims

What is claimed is:

1. A cover assembly (100) for a cargo bed (201) of a pickup truck (200), comprising:
a plurality of rails (101, 102) optionally mounted on sidewalls (201a) of the cargo bed (201) of the pickup truck (200);
a plurality of panels (103, 104, 105, 106, 107);
a plurality of edge frames (108a-108h) configured and supported on the plurality of rails (101, 102) or on a top sill of the sidewall (201a) with anchor points, wherein each edge frame of the plurality of edge frames (108a-108h) comprises a pair of edge brackets (117, 118) fixed together to form a first-panel gap (G1), and a second-panel gap (G2) therebetween for receiving an edge portion of a first panel (106), and a second panel (104) of the plurality of panels (103, 104, 105, 106, 107) there inside; and
a plurality of corner frames (109), wherein each corner frame of the plurality of corner frames (109) comprises a pair of corner brackets (112, 113) fixed together to form a first edge frame gap (C1), a second edge frame gap (C2), and a third edge frame gap (C3) therebetween for receiving a side portion of a first edge frame (108a), a second edge frame (108b) and a third edge frame (108c) of the plurality of edge frames (108a-108h) respectively; and
wherein the plurality of panels (103, 104, 105, 106, 107), the plurality of edge frames (108a-108h), and the plurality of corner frames (109) when assembled together form a canopy with a loading space there inside.

2. The cover assembly (100) of claim 1, wherein the pair of edge brackets (117, 118) comprises a first edge bracket (117) and a second edge bracket (118) structurally identical and comprise a first segment (121), a second segment (122), and optionally a curved portion (123) configured therebetween with a plurality of holes (124).

3. The cover assembly (100) of claim 2, wherein the curved portion (123) is integral with the first segment (121) and the second segment (122).

4. The cover assembly (100) of claim 2, wherein the first edge bracket (117) and the second edge bracket (118) are fixed together by means of a bolted joint.

5. The cover assembly (100) of claim 2, wherein the pair of corner brackets (112, 113) comprises a first corner bracket (112), and a second corner bracket (113) having a first arm (125), a second arm (126), a third arm (127), each configured with a plurality of holes.

6. The cover assembly (100) of claim 5, wherein the first arm (125), the second arm (126), and the third arm (127) are integral.

7. The cover assembly (100) of claim 5, wherein the first corner bracket (112) and the second corner bracket (113) are fixed to ends of the length of the edge brackets (117, 118) at a required point along the length to stop the movement and loosening of the structure by means of a bolted joint using an asymmetrical nut (128).

8. The cover assembly (100) of claim 7, wherein the asymmetrical nut (128) comprises a plurality of sides, each adapted to have a different thickness.

9. The cover assembly (100) of claim 7, wherein the asymmetrical nut (128) comprises a threaded hole (129) for bolt engagement.

10. The cover assembly (100) of claim 1, wherein the cover assembly (100) is removable from the cargo bed (201) for installation on another cargo bed of another truck.

11. The cover assembly (100) of claim 1, wherein the plurality of edge frames (108a-108h) of the cover assembly (100) is slidably adjustable within the edge frame gaps (C1-C3) of each of the plurality of corner frames (109) in order to allow the cover assembly (100) to be used with a differently sized cargo bed (201) of the pickup truck (200).

12. The cover assembly (100) of claim 1 further comprising a support assembly (170) mounted onto the plurality of rails (101, 102), wherein the support assembly (170) comprises a plurality of beams (171) and a plurality of columns (172) connected together by means of a plurality of connectors (173).

13. The cover assembly (100) of claim 1, wherein at least one panel (104)) of the plurality of panels (103, 104, 105, 106, 107) comprises a door assembly (150) configured thereon, the door assembly (150) comprises at least one door flap (131) movably hinged to the panel (104).

14. A cover assembly (100) for a cargo bed (201) of a pickup truck (200) comprising:
a plurality of rails (101, 102) optionally mounted on sidewalls (201a) of the cargo bed (201) of the pickup truck (200);
a plurality of panels (103, 104, 105, 106, 107);
a plurality of edge frames (108a-108h) configured and supported on the plurality of rails (101, 102) or on a top sill of the sidewall (201a) with anchor points, wherein each edge frame of the plurality of edge frames (108a-108h) comprises a pair of edge brackets (117, 118) fixed together to form a first-panel gap (G1), and a second-panel gap (G2) therebetween for receiving an edge portion of a first panel (106), and a second panel (104) of the plurality of panels (103, 104, 105, 106, 107) there inside; and
a plurality of corner frames (109), wherein each corner frame of the plurality of corner frames (109) comprises a pair of corner brackets (112, 113) fixed together to form a first edge frame gap (C1), a second edge frame gap (C2), and a third edge frame gap (C3) therebetween for receiving a side portion of a first edge frame (108a), a second edge frame (108b) and a third edge frame (108c) of the plurality of edge frames (108a-108h) respectively; and
wherein at least one panel (104)) of the plurality of panels (103, 104, 105, 106, 107) comprises a door assembly (150) configured thereon, the door assembly (150) comprises at least one door flap (131) movably hinged to the panel (104);
wherein the plurality of panels (103, 104, 105, 106, 107), the plurality of edge frames (108a-108h), and the plurality of corner frames (109) when assembled together form a canopy with a loading space there inside.

15. The cover assembly (100) of claim 14, wherein an edge portion of at least one door flap (131) is hinged to the panel (104) using at least one door hinge.

16. The cover assembly (100) of claim 14, wherein the door assembly (150) comprises more than one door flap (131, 132, 133, 134, 135).

17. The cover assembly (100) of claim 16, wherein more than one door flaps (131, 132, 133, 134, 135) is selectively couplable by means of a door lock to couple them together.

18. The cover assembly (100) of claim 14 further comprising a support assembly (170) mounted onto the plurality of rails (101, 102), wherein the support assembly (170) comprises a plurality of beams (171) and a plurality of columns (172) connected together by means of a plurality of connectors (173).

19. A cover assembly (100) for a cargo bed (201) of a pickup truck (200) comprising:
a plurality of rails (101, 102) optionally mounted on sidewalls (201a) of the cargo bed (201) of the pickup truck (200);
a plurality of panels (103, 104, 105, 106, 107);
a plurality of edge frames (108a-108h) configured and supported on the plurality of rails (101, 102) or on a top sill of the sidewall (201a) with anchor points, wherein each edge frame of the plurality of edge frames (108a-108h) comprises a pair of edge brackets (117, 118) fixed together to form a first-panel gap (G1), and a second-panel gap (G2) therebetween for receiving an edge portion of a first panel (106), and a second panel (104) of the plurality of panels (103, 104, 105, 106, 107) there inside; and
a plurality of corner frames (109), wherein each corner frame of the plurality of corner frames (109) comprises a pair of corner brackets (112, 113) fixed together to form a first edge frame gap (C1), a second edge frame gap (C2), and a third edge frame gap (C3) therebetween for receiving a side portion of a first edge frame (108a), a second edge frame (108b) and a third edge frame (108c) of the plurality of edge frames (108a-108h) respectively;
a support assembly (170) mounted onto the plurality of rails (101, 102), the support assembly (170) comprises a plurality of beams (171) and a plurality of columns (172) connected together by means of a plurality of connectors (173);
wherein the plurality of panels (103, 104, 105, 106, 107), the plurality of edge frames (108a-108h), and the plurality of corner frames (109) when assembled together form a canopy with a loading space there inside; and
wherein the support assembly (170) provides strength or rigid support to the canopy.

20. The cover assembly (100) of claim 19, wherein the plurality of columns (172) and the plurality of beams (171) are telescopic.

21. The cover assembly (100) of claim 19, wherein the plurality of columns (172) and/or the plurality of beams (171) are fastened to the cover assembly (100) by means of clips and straps (174).

22. The cover assembly (100) of claim 19, wherein the plurality of columns (172) and/or the plurality of beams (171) are arranged inside the cover assembly (100) in a predefined arrangement.

23. The cover assembly (100) of claim 21, wherein the plurality of edge frames (108a-108h) are provided with one or more slits to facilitate fastening of the Cover assembly (100) to the support assembly (170) using the clips and straps (174).

24. The cover assembly (100) of claim 19, wherein at least one panel (104) of the plurality of panels (103, 104, 105, 106, 107) comprises a door assembly (150) configured thereon, the door assembly (150) comprises at least one door flap (131) movably hinged to the panel (104).
